(19) United States
(12) Patent Application Publication
(10) Pub. No.: US 2021/0156174 A1
(43) Pub. Date: May 27, 2021

(54) MOTOR VEHICLE DOOR HANDLE ARRANGMENT WITH AN EMERGENCY ACTUATING LEVER

(71) Applicant: HUF HULSBECK & FURST GMBH & CO. KG, Velbert (DE)

(72) Inventor: Michael KALESSE, Ratingen (DE)

(73) Assignee: HUF HULSBECK & FURST GMBH & CO. KG, Velbert (DE)

(21) Appl. No.: 16/954,295

(22) PCT Filed: Nov. 7, 2018
(86) PCT No.: PCT/EP2018/000505

§ 371 Date: Jun. 16, 2020

(30) Foreign Application Priority Data
Dec. 22, 2017 (DE) 10 2017 012 025.0

(51) Int. Cl. E05B 81/14; E05B 81/76; E05B 81/90; E05B 85/10; E05B 77/12

(52) U.S. Cl. CPC E05B 81/14; E05B 81/76; E05B 77/12; E05B 85/10; E05B 81/90

(57) ABSTRACT

A motor vehicle door handle arrangement for actuating a door lock and/or door of a motor vehicle, with a handle housing and an actuating element which is arranged in or on the handle housing and, when actuated by a user when the door lock is unlocked, permits opening of the door. The motor vehicle door handle arrangement additionally has an emergency actuating lever acting mechanically on the door lock, for opening the door.

The invention relates to a motor vehicle door handle arrangement according to the preamble of claim 1.

Motor vehicle door handle arrangements of this type for actuating a door lock and/or door of a motor vehicle, with a handle housing and an actuating element arranged in or on the handle housing, which, when actuated by a user when the door lock is unlocked, enables the door to be opened, are known.

It is, however, a disadvantage of the known motor vehicle door handle arrangements for actuating a door lock and/or door of a motor vehicle that, in the event of an accident, the opening of the door is made difficult or even impossible for persons assisting if the actuating element, which is intended to enable a door to be opened when actuated by a user when the door lock is unlocked, has been damaged by the accident.

It is the object of the present invention to create a motor vehicle door handle arrangement that enables the door to be opened in particular in the event of an accident when the actuating element has been damaged.

This object is achieved according to the invention by a motor vehicle door handle arrangement according to claim 1. Advantageous developments of the invention are given in the dependent claims.

It is particularly advantageous in the motor vehicle door handle arrangement for actuating a door lock and/or door of a motor vehicle, with a handle housing and an actuating element arranged in or on the handle housing, which, when actuated by a user when the door lock is unlocked, enables the door to be opened, that the motor vehicle door handle arrangement additionally has an emergency actuating lever acting mechanically on the door lock to open the door.

The door lock of a motor vehicle door can be locked and unlocked e.g. by actuating a remote control and/or a key. When the door lock is unlocked, the door can be opened using the actuating element when actuated by a user. The door can in particular be a motor vehicle side door or a motor vehicle tailgate.

By the arrangement of an additional emergency actuating lever acting mechanically on the door lock to open the door, it is possible to open the door even when the actuating element is damaged, as can be the case e.g. in an accident to the motor vehicle. In this case, the door can be opened by actuating the emergency actuating lever. According to the invention, therefore, an emergency actuating lever for opening the door is arranged in addition to the actuating element for opening the door.

Preferably, the actuating element is formed by a push-button, which acts on a microswitch and effects an electric door lock actuation by way of the microswitch and enables the door to be opened. The push-button that forms the actuating element acts on the microswitch directly or indirectly, e.g. via a lever. In this case, the lever and the push-button can in particular be designed as a one-piece injection-molded part. Preferably, the emergency actuating lever can be shifted from a rest position to an actuation position in which the emergency actuating lever acts on the door lock indirectly or directly. In particular, the emergency actuating lever can act on a Bowden cable via a lever or a pivoted lever, wherein the Bowden cable is connected to the door lock and effects an opening of the door lock when the emergency actuating lever is shifted from its rest position to the actuating position.

Preferably, the emergency actuating lever in a rest position is located in the handle housing in a form-fitting and/or force-fitting manner. In this case, the emergency actuating lever in a rest position can be located in the handle housing such that it is flush-mounted or protruding or recessed. In the case of a flush-mounted arrangement of the emergency actuating lever in the handle housing in its rest position, the emergency actuating lever thus forms a visually continuous surface with the handle housing. In the rest position, the emergency actuating lever thus forms a visually closed part of the motor vehicle door handle arrangement.

In the event of an accident, the emergency actuating lever is unlocked so that it can be grasped from the outside and shifted from a rest position to an actuation position.

Preferably, the emergency actuating lever is fixed in a rest position with a holding force of over 40 Newtons, in particular over 70 Newtons and in particular up to 100 Newtons. The emergency actuating lever in this case can be located in the handle housing in a form-fitting and/or force-fitting manner in the rest position, and in particular the emergency actuating lever can engage behind undercuts in the handle housing using corresponding holding elements so that it is fixed in its rest position with an appropriate holding force. This holding force therefore has to be overcome by a person in order to actuate the emergency actuating lever, the holding force being calculated such that this is possible without further problems when actuated by hand, as explained.

Preferably, the emergency actuating lever can be shifted from a rest position to an actuation position by pulling out the emergency actuating lever to the outside of the motor vehicle door handle arrangement. The emergency actuating lever can be mounted rotatably around an, in particular vertical, axis of rotation in order to be shiftable from its rest position to its actuating position.

The term “outside” here relates to the installed position of the motor vehicle door handle arrangement in the motor vehicle door of a motor vehicle. The motor vehicle door handle arrangement is positioned in the motor vehicle door in such a way that both the actuating element and the emergency actuating lever can be actuated by a user from outside the motor vehicle. The term “outside” thus relates to the entire motor vehicle and the arrangement of the motor vehicle door handle arrangement in the motor vehicle door.

The emergency actuating lever is preferably kinematically coupled to a lever or pivoted lever, wherein the lever or pivoted lever can be coupled to the door lock by way of a Bowden cable. A kinematic coupling of the emergency actuating lever to the door lock by way of the pivoted lever and a Bowden cable enables the door to be opened in an emergency.

In a preferred embodiment, the actuating element in the form of a push-button for actuating the microswitch is spring-loaded towards its rest position. In particular, a leaf spring can be arranged by which the push-button is spring-loaded towards its rest position. As a result, the push-button is shifted back automatically into its rest position after an actuation of the microswitch owing to the spring loading.

Preferably, the actuating element in the form of a push-button for actuating the microswitch is formed by a rocker that can be gripped from behind from the outside through a recess in the handle housing. Accordingly, a recess is provided in the handle housing through which a user can reach into the handle housing and grip the push-button in the form of a rocker from behind. Gripping from behind in this way allows a very convenient and advantageous actuation of the rocker for the user.

Particularly preferably, this rocker is mounted rotatably around an, in particular horizontal, axis of rotation on the bottom edge of the rocker or around an, in particular horizontal, axis of rotation on the top edge of the rocker. Preferably, this axis of rotation on the bottom edge of the rocker or on the top edge of the rocker is arranged horizontally or at an acute angle to the horizontal. This creates a very advantageous arrangement, which facilitates an actuation for a user since the actuating element can be conveniently actuated both with the left hand and with the right hand with such an alignment.

In particular where the actuating element in the form of a push-button for actuating the microswitch, which is formed by a rocker that can be gripped from behind, is mounted so as to rotate around a horizontal axis of rotation on the bottom edge of the rocker, a particularly convenient actuation of the push-button by a user is possible in that the user grasps the rocker from behind from the outside. The rotatable arrangement around a horizontal axis of rotation on the bottom edge of the rocker thus reliably avoids the possibility of the user's being caught in the rocker.

Furthermore, this mounting of the rotatable rocker around a horizontal axis of rotation on the bottom edge of the rocker corresponds to the natural movement of the fingers of a human hand when a user reaches into the motor vehicle door handle arrangement. As a result, the use and actuation are very convenient and intuitive.

Particularly preferably, the motor vehicle door handle arrangement has an operating module, wherein a push-button as an actuating element for actuating a microswitch is arranged in the operating module, as well as the microswitch and a connector for making an electrical connection between the microswitch and the lock. An operating module of this type can thus be produced as a pre-assembled assembly and installed in the motor vehicle door handle arrangement.

The operating module preferably has a spring, by which the push-button is spring-loaded towards its resting position. In particular, the spring can be a leaf spring. The push-button is also shifted back to its resting position automatically after an actuation by such a spring loading of the push-button towards its resting position.

Particularly preferably, the operating module is sealed off from the environment. The term sealing here refers in particular to an acoustic sealing. The operating module here is arranged on the outside of a motor vehicle door as part of a motor vehicle door handle arrangement and is thus exposed to environmental influences such as in particular moisture. The purpose of the sealing of the operating module from the environment here is in particular for the acoustic decoupling of the vehicle interior from the environment to prevent ambient noises from being able to penetrate into the passenger compartment of the motor vehicle. As a result, the driving experience is enhanced for the driver of the motor vehicle.

An exemplary embodiment of the invention is shown in the figures and is explained in more detail below. The figures show the following:

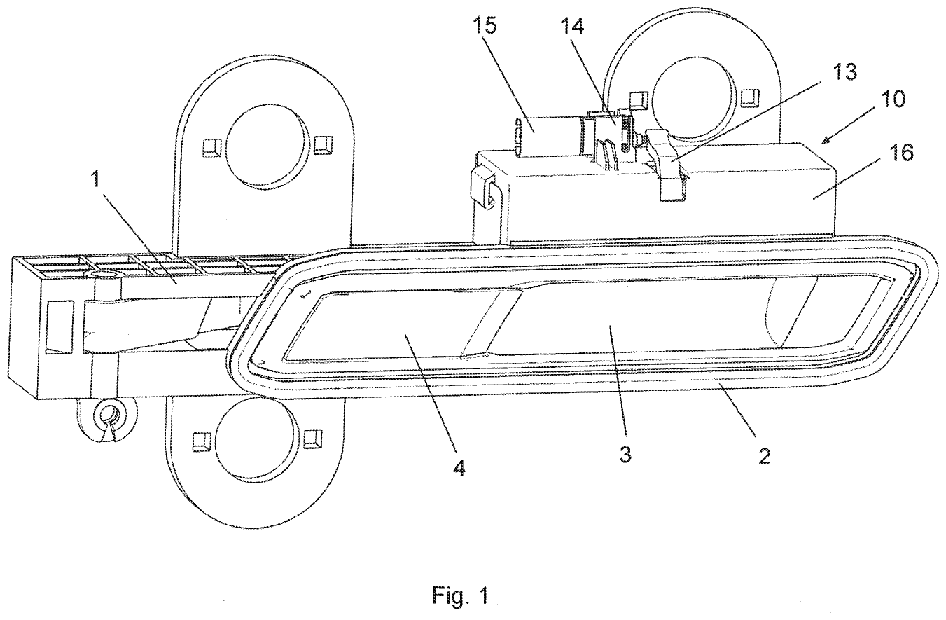

FIG. 1: The front view of an exemplary embodiment of a motor vehicle door handle arrangement with an emergency actuating lever in its rest position and with a cover on the operating module

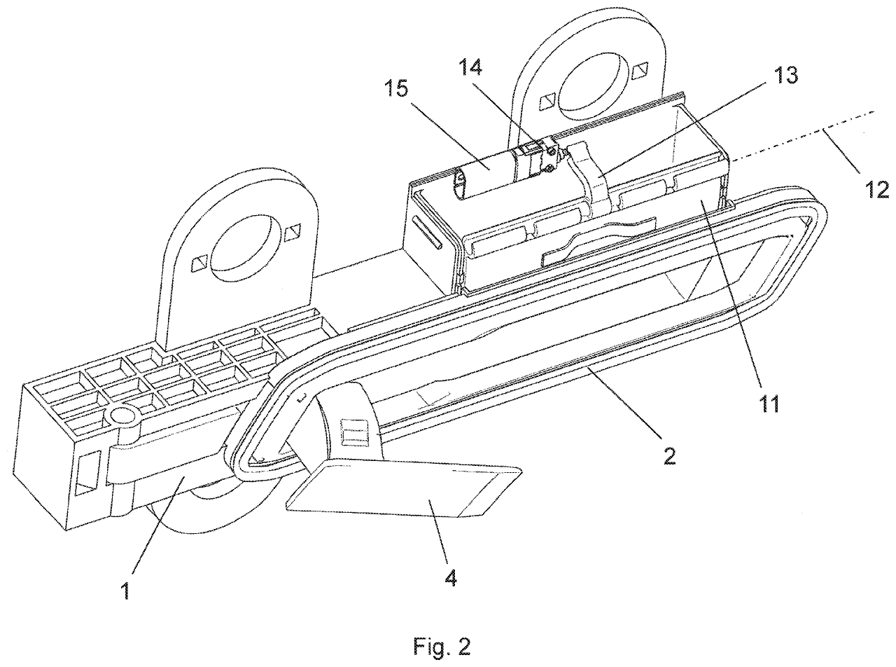

FIG. 2: A perspective view of the motor vehicle door handle arrangement with the emergency actuating lever in its actuating position and without a cover on the operating module

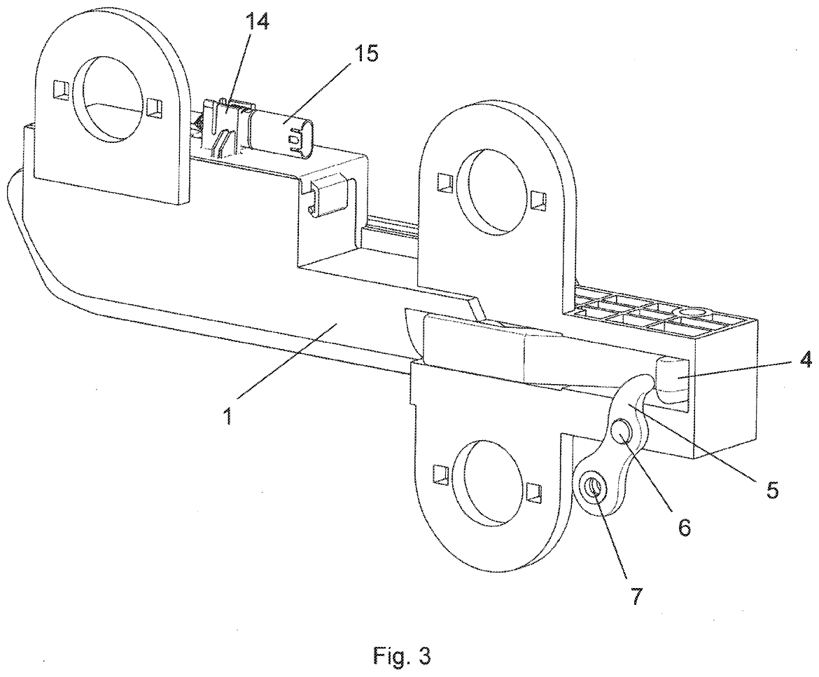

FIG. 3: A perspective rear view of the motor vehicle door handle arrangement

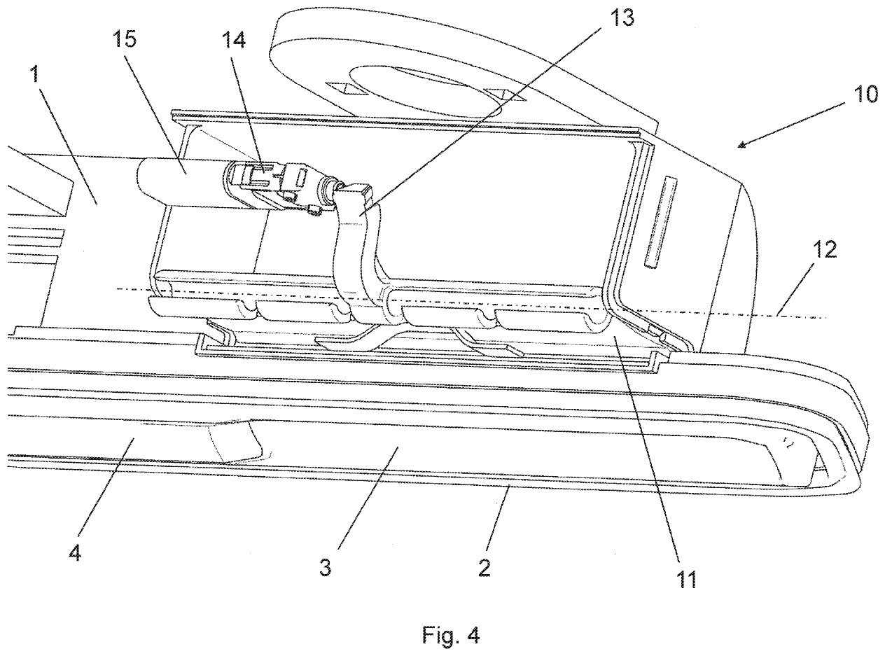

FIG. 4: A perspective view of the operating module of the motor vehicle door handle arrangement without a cover

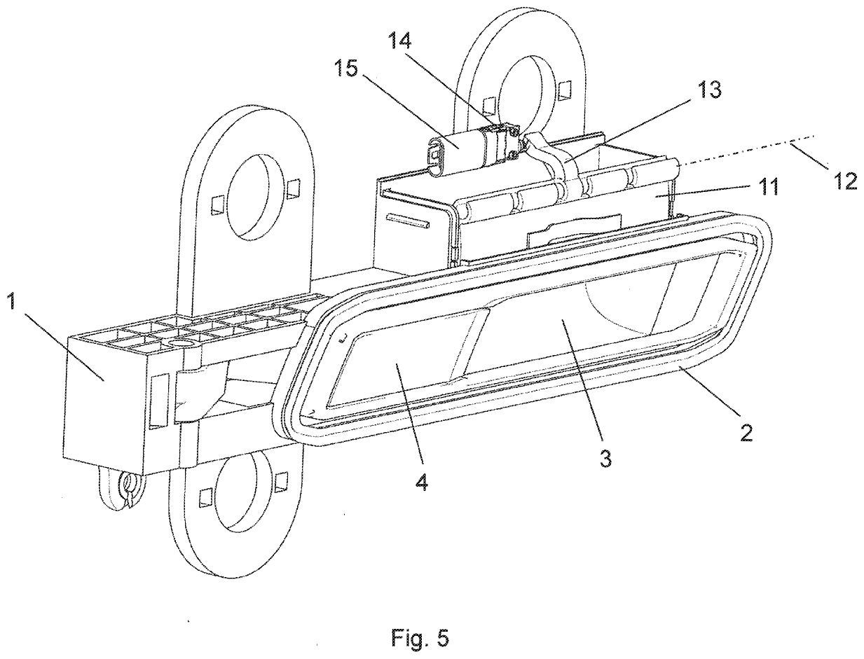

FIG. 5: A further perspective view of the motor vehicle door handle arrangement without a cover on the operating module.

FIG. 1 shows the front view of a motor vehicle door handle arrangement, which is intended for installation in a motor vehicle side door. The motor vehicle door handle arrangement has a handle housing 1. The frame 2, which forms the external visual finish in the motor vehicle body, is formed in one piece with the handle housing 1. The frame 2 has a recess 3, through which the user can reach in and actuate the motor vehicle door handle arrangement.

Furthermore, the operating part of the emergency actuating lever 4 is located flush in the frame 2. In FIG. 1 the emergency actuating lever 4 is in its rest position, in which it is located flush in the frame 2 of the handle housing 1. As can be seen in FIG. 2, the emergency actuating lever can be shifted from the rest position according to FIG. 1 to the actuating position 2. To this end, the emergency actuating lever 4 can likewise be gripped from behind through the recess 3 in the frame 2 and shifted from the rest position according to FIG. 1 to the actuating position according to FIG. 2.

FIG. 3 shows a perspective rear view of the motor vehicle door arrangement. It can be seen here that the emergency actuating lever 4 acts on the pivoted lever 5 when it shifts from its rest position to its actuating position, and rotates the pivoted lever 5 around its axis of rotation 6. At the opposite end, the pivoted lever 5 has an eye 7 for receiving a Bowden cable, by way of which the pivoted lever 5 can be coupled to the door lock. When the emergency actuating lever 4 shifts from the rest position according to FIG. 1 to its actuating position according to FIG. 2, as a result of the kinematic coupling of the emergency actuating lever 4 to the pivoted lever 5, the pivoted lever 5 is rotated around its axis of rotation 6 and an actuation of the door lock takes place by way of the Bowden cable attached at the eye 7 of the pivoted lever 5.

The emergency actuating lever 4 in its rest position is located in the frame 2 of the handle housing 1 in a form-fitting manner. To this end, the emergency actuating lever 4 engages in a form-fitting manner behind corresponding counterparts in the frame 2 of the handle housing 1 by means of appropriate protrusions. This form-fitting fastening of the emergency actuating lever 4 in its rest position in the handle housing 1 can be shifted from the rest position according to FIG. 1 to the actuating position according to FIG. 2 by applying a force of over 70 Newtons. In the rest position according to FIG. 1, the emergency actuating lever 4 is located flush in the frame 2 of the handle housing 1, as explained.

For the actual actuation of the door, the user can grip the push-button 11 in the form of a rocker of the operating module 10 from behind through the recess 3 in the frame 2 of the handle housing 1 and actuate it. The push-button 11 is in the form of a rocker, which is mounted so as to rotate around an axis of rotation 12 at the upper end of the push-button. By a rotation of the push-button 11 around the axis of rotation 12, an actuation of the microswitch 14 takes place by way of the lever 13. The connector 15 for connecting the operating module 10 to the vehicle electronics and the door lock is molded in one piece with the microswitch 14.

Because the axis of rotation 12 of the push-button 11 in the form of a rocker is arranged on the upper edge thereof, a particularly convenient actuation of the push-button 11 is possible for a user through the grip recess 3 in the frame 2 of the handle housing 1 since, when the fingertips are inserted through the recess 3 forming a grip recess, this corresponds to the natural movement of the hand. The lever 13, which acts on the microswitch 14 when the push-button 11 is rotated around the axis of rotation 12, is molded in one piece with the push-button 11.

The operating module 10 here is prefabricated as a pre-assembled unit and comprises the push-button 11, which is mounted so as to rotate around the axis of rotation 12, as well as the lever 13, which is formed in one piece therewith. Furthermore, the pre-assembled operating module 10 comprises the microswitch 14 and the connector which is molded in one piece therewith as a prefabricated assembly. Furthermore, the pre-assembled operating module 10 comprises the cover 16 illustrated in FIG. 1. On the inside of the cover 16, this comprises appropriate coupling elements to fix the push-button 11 in a form-fitting manner to the coupling elements of the cover 16 so as to rotate around the axis of rotation 12. Furthermore, the operating module comprises a leaf spring (not visible in the figures), by which the push-button 11 is spring-loaded towards its resting position in the operating module 10.

The corresponding pre-assembled operating module 10 can thus be fastened on the handle housing 1 of the motor vehicle door handle arrangement as a prefabricated assembly. This also, particularly advantageously, creates an assembly that can be fitted in the motor vehicle.

Should it not be possible for the user to open a door by actuating the push-button 11 as a result of a fault in the electronics or other components, for example after an accident to the vehicle, it is then possible to grip the emergency actuating lever 4 from behind through the recess 3 in the frame 2 of the handle housing 1 and, by actuating the emergency actuating lever 4, i.e. by shifting it from its rest position according to FIG. 1 to its actuating position corresponding to FIG. 2, a door opening can be effected.

In principle, however, the emergency actuating lever 4 serves to open a door only in an emergency and not in general operation. The emergency actuating lever 4 is therefore fixed in a form-fitting manner by appropriate lugs, which engage behind corresponding protrusions on the frame 2 of the handle housing 1, so that it has an increased holding force compared to a normal door handle. This means that a force of over 70 Newtons has to be applied in order to shift the emergency actuating lever 4 from its rest position according to FIG. 1 to the actuating position corresponding to FIG. 2.

1.-15. (canceled)

16. A motor vehicle door handle arrangement for actuating a door lock and/or door of a motor vehicle, with a handle housing and an actuating element arranged in or on the handle housing, which, when actuated by a user when the door lock is unlocked, enables the door to be opened, wherein the motor vehicle door handle arrangement additionally comprises an emergency actuating lever acting mechanically on the door lock for opening the door.

17. The motor vehicle door handle arrangement according to claim 16, wherein the actuating element is formed by a push-button, which acts on a microswitch and effects an electric door lock actuation by way of the microswitch and enables the door to be opened.

18. The motor vehicle door handle arrangement according to claim 16, wherein the emergency actuating lever can be shifted from a rest position to an actuation position in which the emergency actuating lever acts on the door lock indirectly or directly.

19. The motor vehicle door handle arrangement according to claim 16, wherein the emergency actuating lever in a rest position is located in the handle housing in a form-fitting and/or force-fitting manner.

20. The motor vehicle door handle arrangement according to claim 16, wherein the emergency actuating lever in a rest position is located in the handle housing such that it is flush-mounted or protruding or recessed.

21. The motor vehicle door handle arrangement according to claim 16, wherein the emergency actuating lever is fixed in a rest position with a holding force of over 40 N, in particular of 70 N and in particular of up to 100 N.

22. The motor vehicle door handle arrangement according to claim 16, wherein the emergency actuating lever can be shifted from a rest position to an actuation position by pulling out the emergency actuating lever to the outside of the motor vehicle door handle arrangement.

23. The motor vehicle door handle arrangement according to claim 16, wherein the emergency actuating lever is kinematically coupled to a pivoted lever, wherein the pivoted lever is coupled to the door lock via a Bowden cable.

24. The motor vehicle door handle arrangement according to claim 16, wherein the push-button for actuating the microswitch is formed by a rocker.

25. The motor vehicle door handle arrangement according to claim 16, wherein the actuating element in the form of a push-button for actuating the microswitch is spring-loaded towards its rest position, and in particular in that a leaf spring is arranged, by which the push-button is spring-loaded towards its rest position.

26. The motor vehicle door handle arrangement according to claim 16, wherein the actuating element in the form of a push-button for actuating the microswitch is formed by a rocker that can be gripped from behind from the outside through a recess in the handle housing.

27. The motor vehicle door handle arrangement according to claim 16, wherein the actuating element in the form of a push-button for actuating the microswitch is formed by a rocker that can be gripped from behind, which is mounted so as to rotate around a horizontal axis of rotation on the bottom edge of the rocker or around a horizontal axis of rotation on the top edge of the rocker.

28. The motor vehicle door handle arrangement according to claim 16, wherein the motor vehicle door handle arrangement comprises an operating module, wherein a push-button as an actuating element for actuating a microswitch, as well as the microswitch and a connector to make an electrical connection between the microswitch and the door lock, are arranged in the operating module.

29. The motor vehicle door handle arrangement according to claim 28, wherein a spring, in particular a leaf spring, by which the push-button is spring-loaded towards its resting position, is arranged in the operating module.

30. The motor vehicle door handle arrangement according to claim 28, wherein the operating module is sealed off from the environment.

31. A motor vehicle door handle arrangement for actuating a door lock of a motor vehicle, with a handle housing and an actuating element arranged in or on the handle housing, which, when actuated by a user when the door lock is unlocked, enables a door to be opened, wherein the motor vehicle door handle arrangement additionally comprises an emergency actuating lever acting mechanically on the door lock for opening the door.

32. A motor vehicle door handle arrangement for actuating a door of a motor vehicle, with a handle housing and an actuating element arranged in or on the handle housing, which, when actuated by a user when a door lock is unlocked, enables the door to be opened, wherein the motor vehicle door handle arrangement additionally comprises an emergency actuating lever acting mechanically on the door lock for opening the door.
